(19) United States
(12) Patent Application Publication
(10) Pub. No.: US 2012/0244803 A1
(43) Pub. Date: Sep. 27, 2012

(54) COMMUNICATION SYSTEM, COMMUNICATION DEVICE, AND COMMUNICATION METHOD

(76) Inventors: Tomohiro Sudou, Yokohama (JP); Motoaki Abe, Yokohama (JP); Atsuo Chiba, Yokohama (JP); Nayu Nomachi, Yokohama (JP); Hiroshi Tsuruta, Yokohama (JP)

(21) Appl. No.: 13/240,622

(22) Filed: Sep. 22, 2011

(30) Foreign Application Priority Data
Sep. 22, 2010 (JP) 2010-212874

(51) Int. Cl. H04B 5/00

(52) U.S. Cl. 455/41.1

(57) ABSTRACT

A communication system includes a first communication device and a second communication device. The first communication device includes a first near field communication part, a state detection part, and a first control part. The first control part, based on the state of the device itself detected by the state detection part, selects an output pattern for signals output from the first near field communication part and controls the first near field communication part so as to output signals of the selected output pattern. The second communication device includes a notification part, a second near field communication part, a memory, and a second control part. The second control part identifies the state of the first communication device corresponding to the pattern of the received signals, and provides notification of the identified state of the first communication device via the notification part.

### CROSS-REFERENCE TO RELATED APPLICATION

The present application claims priority under 35 U.S.C. §119 to Japanese Patent Application No. 2010-212874, filed on Sep. 22, 2010, entitled “COMMUNICATION SYSTEM AND COMMUNICATION DEVICE”. The content of which is incorporated by reference herein in its entirety.

### FIELD

Embodiments of the present disclosure relate generally to a communication system comprising a communication device that performs near field communication, a communication device that performs near field communication with another communication device, and a communication method.

### BACKGROUND

In recent years, electronic devices such as mobile phones, PDAs and personal computers include those that comprise functions for communication with other electronic devices (communication devices) through near field communication. There are also wireless headset systems that allow for the main body and the headset to be separated by using functions for near field communication in the headset (refer to Patent Document 1).

A communication device that performs near field communication performs a pairing process with the communication device being communicated with (the communication partner), and then executes the transmission and reception of desired data. By performing the pairing process, the communication device is able to execute communication with a specific communication partner and a desired communication device, even if there are multiple communication devices with which communication is possible within the area. In other words, if there are multiple communication partners with which communication is possible, the communication device must select a communication partner with which to perform near field communication (i.e., a communication partner with which to perform the pairing process) from among the communication partners with which communication is possible.

Here, when selecting a communication partner from among electronic devices with which communication is possible, the information that can be obtained through near field communication is information such as the model of the communication partner. Therefore, the user must select the communication partner based on the model number or identification number of the communication partner, and it is bothersome to determine which electronic device is the desired communication partner. Moreover, making this determination becomes difficult if the electronic devices with which communication is possible are of the same model, or have similar identification numbers. Furthermore, if the wrong partner is selected for the pairing process, this leads to the problem that data are sent and received with an unintended electronic device.

### SUMMARY

A communication system is disclosed. The communication system includes a first communication device and a second communication device. The first communication device includes a first near field communication part, a state detection part, and a first control part. The first near field communication part performs near field communication. The state detection part detects the state of the device itself. The first control part, based on the state of the device itself detected by the state detection part, selects an output pattern for signals output from the first near field communication part and controls the first near field communication part so as to output signals of the selected output pattern. The second communication device includes a notification part, a second near field communication part, a memory, and a second control part. The second near field communication part performs near field communication with the first communication device. The memory part stores the patterns of signals received by the second near field communication part associated with the state of the communication device. The second control part, in accordance with the pattern of signals received by the second near field communication part, identifies the state of the first communication device corresponding to the pattern of the received signals, and provides notification of the identified state of the first communication device via the notification part.

A communication device is disclosed. The communication device includes a near field communication part, a state detection, and a control part. The near field communication part performs near field communication with another communication device. The state detection part detects the state of the communication device itself. The control part, in accordance with the state of the communication device itself detected by the state detection part, selects a pattern for signals to be output from the near field communication part from among multiple patterns, and control the first near field communication part so as to output signals of the selected pattern.

A communication device is disclosed. The communication device includes a notification part, a near field communication part, a memory, and a control part. The near field communication part performs near field communication with another communication device. The memory part stores the pattern of signals received via near field communication associated with the state of the communication device. The control part, in accordance with the pattern of signals received from the other communication device by the near field communication part, identifies the state of the other communication device, and provides notification of the identified state of the other communication device via the notification part.

A communication method for a communication device is disclosed. The communication method includes selecting an output pattern for signals by a first communication device, based on the state of the first communication device, outputting signals of the selected output pattern by the first communication device, identifying the state of the first communication device in accordance with the pattern of received by a second communication device, and providing notification of the identified state of the first communication device corresponding to the pattern of the received signals by the second communication device.

A communication method for a communication device is disclosed. The communication method for a communication device includes detecting the state of the communication device itself, selecting a pattern for signals to be output from among multiple patterns in accordance with the state of the communication device itself detected and outputting signals of the selected pattern.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1 is an explanatory diagram showing an outline configuration of a communication system according to the present invention, comprising a mobile communication device according to the present invention.

FIG. 2 is a frontal view showing an outline configuration of the mobile communication device according to the present invention shown in FIG. 1.

FIG. 3 is a block diagram showing an outline configuration of the mobile communication device shown in FIG. 2.

FIG. 4 is an explanatory diagram of the processing operations of a communication device.

FIG. 5 is an explanatory diagram of the processing operations of a communication device.

FIG. 6 is an explanatory diagram of the processing operations of a communication device.

FIG. 7 is a block diagram showing one example of a processing operation of a mobile communication device.

FIG. 8 is a block diagram showing one example of a processing operation of a mobile communication device.

FIG. 9 is a block diagram showing one example of a processing operation of a mobile communication device.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary or the following detailed description. The present disclosure should be accorded scope consistent with the claims, and not limited to the examples described and shown herein.

Embodiments of the disclosure are described herein in the context of one practical non-limiting application, namely, an information device. Embodiments of the disclosure, however, are not limited to such mobile information devices, and the techniques described herein may also be utilized in other applications. For example, embodiments may be applicable to mobile phones, digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

The present invention will now be described in detail with reference to the drawings. It should be noted that the following descriptions do not limit the present invention. Moreover, the components in the following descriptions include those that may be easily devised by persons skilled in the art, those that are practically identical, and those within the range of equivalence. In the following sections, a mobile phone will be described as an example of a communication device, but the scope of application of the present invention is not limited to mobile phones, and the present invention may be used for various communication devices (electronic devices) comprising functions for near field communication. Examples of communication devices to which the present invention may be applied include PHSs (Personal Handy-phone Systems), PDAs (Personal Digital Assistants), portable navigation devices, personal computers, and gaming devices. Furthermore, the present invention may also be used for electronic devices comprising functions for near field communication, such as a wireless mouse, a wireless keyboard, or wireless headphones.

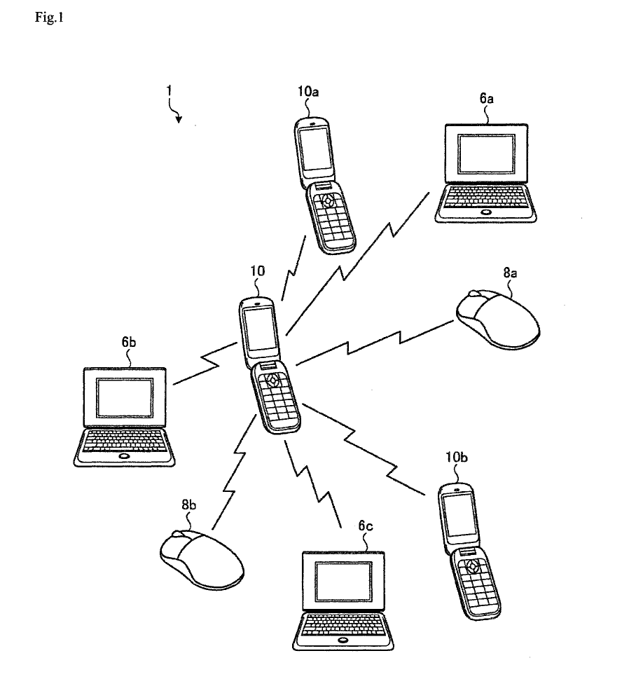

FIG. 1 is an explanatory diagram showing an outline configuration of a communication system according to the present invention, comprising a mobile communication device according to the present invention. The communication system 1 shown in FIG. 1 is configured by multiple personal computers 6, 6a, 6b, 6c, multiple mice 8a, 8b, and multiple mobile communication devices 10, 10a, 10b.

The personal computers (PCs) 6, 6a, 6b are arithmetic devices comprising functions for near field communication. The mice 8a, 8b are input devices comprising functions for near field communication. The mouse 8a performs near field communication with the PC 6a, and acts as an input device for the PC 6a when operations are input. The mouse 8b performs near field communication with the PC 6b, and acts as an input device for the PC 6b when operations are input.

The mobile communication devices 10, 10a, 10b are communication terminals that perform near field communication. The mobile communication devices 10, 10a, 10b are capable of executing communication via a public telecommunication network, and transmit audio signals and other signals to the public telecommunication network and receive audio signals and other signals from the public telecommunication network. Moreover, individual telephone numbers and terminal numbers are assigned to and stored in each mobile communication terminal. The configurations of the mobile communication devices 10, 10a, 10b will be described later.

The communication system 1 is configured as described above. The communication system 1 is configured by the mobile communication device 10 and various communication devices with which near field communication is possible. Through its functions for near field communication, the mobile communication device 10 is capable of transmitting and receiving information with each of the multiple PCs 6, 6a, 6b, 6c, the multiple mice 8a, 8b, and the multiple mobile communication devices 10a, 10b. In other words, communication system 1 is configured by the mobile communication device 10, and communication devices that are not only within an area in which the mobile communication device 10 can perform near field communication but also comprise functions for near field communication. The number of communication devices other than the mobile communication device 10 configuring the communication system 1 is not particularly limited. The types of communication devices are not limited to mobile communication devices, mice, and PCs.

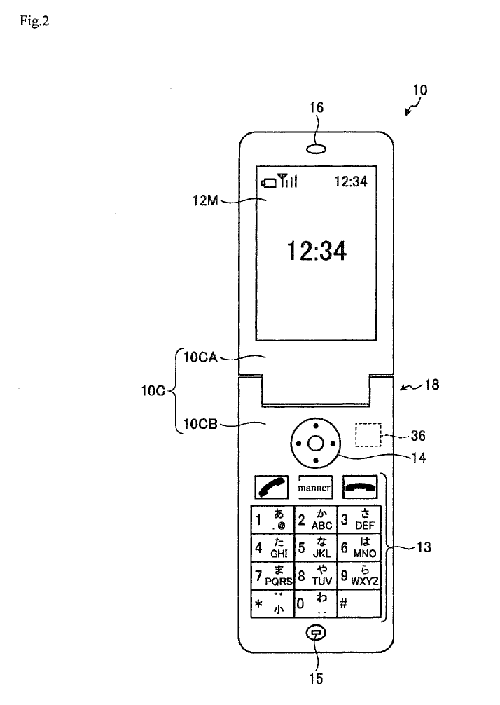

The following is a description of the mobile communication devices 10, 10a, 10b. Because the mobile communication device 10, the mobile communication device 10a, and the mobile communication device 10b have identical device configurations, the following description uses the mobile communication device 10. FIG. 2 is a frontal view showing an outline configuration of the mobile communication device shown in FIG. 1. The mobile communication device 10 is a mobile phone comprising functions for wireless communication. The mobile communication device 10 is a folding mobile phone, with a chassis 10C configured to be openable and closable with a first chassis 10CA and a second chassis 10CB. FIG. 2 shows the mobile communication device 10 in an open state. It should be noted that in the present embodiment, the chassis 10C of the mobile communication device 10 has been made a folding type, but the form of the chassis is not particularly limited. The chassis may be of various modes, and examples include a sliding type, a cycloid type, a revolver type, and a straight type.

On the first chassis 10CA, a main display 12M shown in FIG. 2 is provided as a display part. The main display 12M displays a standby screen when the mobile communication device 10 is in a state awaiting reception, or a menu image used for aiding operation of the mobile communication device 10, as prescribed images. As shown in FIG. 2, the first chassis 10CA is provided with a receiver 16 that emits audio during communication using the mobile communication device 10.

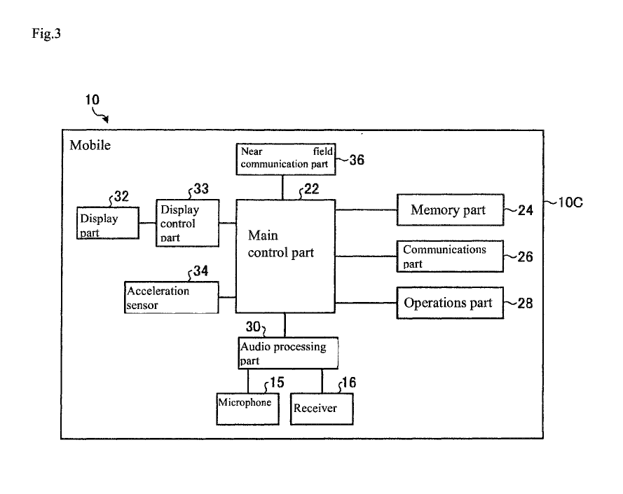

On the second chassis 10CB, multiple operational keys 13 for inputting the phone number of a communication partner or characters when writing a text message are provided, and furthermore, direction and enter keys 14 for easily executing the selection and entering of a menu item displayed on the main display 12M or scrolling of the screen, etc. are provided. The operational keys 13 and the direction and enter keys 14 configure the operations part 28 (refer to FIG. 3) of the mobile communication device 10. The second chassis 10CB is also provided with a microphone 15 that receives audio during communication using the mobile communication device 10. Moreover, a near field communication part 36 is built into the second chassis 10CB.

The first chassis 10CA and the second chassis 10CB are coupled by a hinge 18. In this way, the first chassis 10CA and the second chassis 10CB are configured to be able to turn with the hinge 18 at the center, and to turn in directions moving away and toward each other. When the first chassis 10CA and the second chassis 10CB turn in directions moving away from each other, the mobile communication device 10 opens, and when the first chassis 10CA and the second chassis 10CB turn in directions moving toward each other, the mobile communication device 10 closes.

Next, the relationship between the functions of the mobile communication device 10 and the control part is described. FIG. 3 is a block diagram showing an outline configuration of the functions of the mobile communication device shown in FIG. 2. As shown in FIG. 3, the mobile communication device 10 comprises a main control part 22, a memory part 24, a communications part 26, the operations part 28, an audio processing part 30, a display part 32, a display control part 33, an acceleration sensor 34, and the near field communication part 36.

The main control part 22 is a processing part (e.g., a CPU [Central Processing Unit]) that performs overall control of all operations of the mobile communication device 10. In other words, the main control part 22 controls the operations of the communications part 26 and the display part 32, etc. so that the various processes of the mobile communication device 10 are executed through appropriate procedures in accordance with operations of the operations part 28 or with software stored in the memory part 24 of the mobile communication device 10. The main control part 22 executes processes based on programs stored in the memory part 24 (e.g., operating system programs, application programs, etc.). Furthermore, the main control part 22 is capable of executing multiple programs (applications, software) simultaneously.

In the memory part 24, programs and data for applications used in processes of the main control part 22 are stored. Specifically, application programs that are stored include programs for applications that perform transmission, reception and communication processes, programs for applications that perform transmission and reception of text messages, and programs for applications that perform near field communication, etc. Data that are stored include image data, audio data, dictionary data for character conversion, address-book data, tables of control conditions for near field communication, and output patterns for near field communication, etc.

The communications part 26 establishes a wireless signal line with a communications network using, for example, a CDMA system via a channel assigned by the communications network, and performs telephone communication and information communication with the communications network. As a result, through communication using the communications part 26, the user is able to transmit and receive data or talk with a desired partner.

The operations part 28 is configured by the operational keys 13 to which various functions have been assigned (e.g., a power key, a call key, number keys, character keys and a transmission key), and the direction and enter keys 14. When inputs are made through these keys through a user operation, the operations part 28 releases a signal corresponding to the details of that operation. Then, the released signal is input into the main control part 22 as a user instruction.

The audio processing part 30 executes processing of audio signals input into the microphone 15 and audio signals output from the receiver 16.

The display part 32 comprises an LCD (Liquid Crystal Display) or a display panel (the main display 12M described above, etc.) configured by an Organic EL (Organic Electro-Luminescence) panel, etc., and causes the display panel to display footage or images corresponding to footage data or image data supplied from the main control part 22 via the display control part 33.

The acceleration sensor 34 is a detector that detects the acceleration applied to the chassis 10C. Detectors that detect acceleration using various methods may be used for the acceleration sensor 34, and examples include detectors that detect acceleration based on changes in capacitance, changes in piezoresistance, or changes in relative position. The acceleration sensor 34 detects the acceleration acting on the chassis 10C when the operator moves or shakes the chassis 10C, and sends the detected acceleration information to the main control part 22.

The near field communication part 36 is a communications part that performs communication with other communications devices by using near field communication technology. The near field communication technology used may be Infrared Data Association (IrDA) (registered trademark), IrMC (registered trademark), IrSimple (registered trademark), visible light communication, Bluetooth (registered trademark), or Radio Frequency Identification (RFID) technology. For example, if the near field communication part 36 uses Bluetooth (registered trademark), it comprises an output part that outputs signals and a reception part that receives signals.

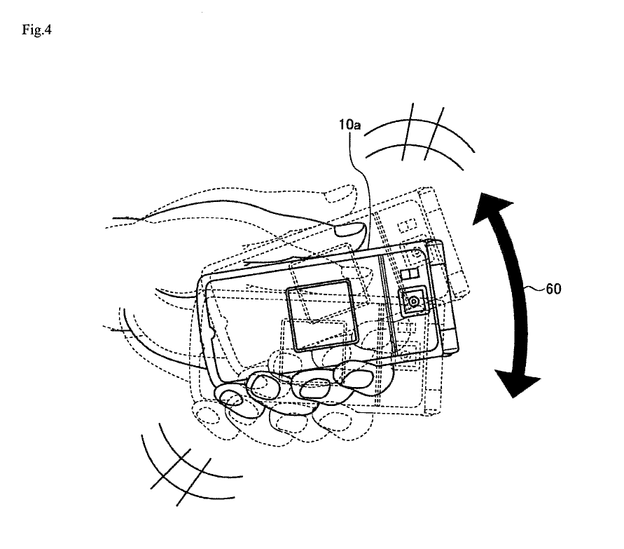

Next, operations of the communication system 1 and the mobile communication device 10 will be described with reference to FIG. 4 through FIG. 6. The following description uses an example in which the mobile communication device 10 selects the mobile communication device 10 as a communication partner from among the communication devices with which communication is possible.

First, as setting conditions for near field communication using the near field communication part 36, the mobile communication device 10a is set so that, if the acceleration sensor 34 determines that the device itself (the chassis 10C) is in a shaking state, the output pattern of the signals output from the near field communication part 36 is a preset pattern. Moreover, in the mobile communication device 10, the relationship between the output pattern of a received signal and the state of the communication device that output the signal is stored in the memory part 24.

When near field communication is started, after activating the near field communication part 36, the mobile communication device 10 obtains information on the communication devices with which communication is possible. In the present embodiment, near field communication is performed with the multiple PCs 6, 6a, 6b, 6c, the multiple mice 8a, 8b, and the multiple mobile communication devices 10a, 10b, and information on each communication device is obtained. Although the mobile communication device 10 has obtained information on each communication device, because the pairing process has not been performed, the mobile communication device 10 is in a state in which it cannot transmit or receive the above data that have been set.

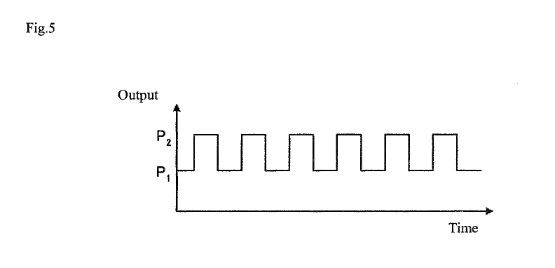

Here, when the mobile communication device 10a is shaken by the user in the direction of the arrow 60 as shown in FIG. 4, the oscillation is detected by the acceleration sensor 34 and it is determined that the mobile communication device 10a is being shaken. When it is determined that the mobile communication device 10a is being shaken, the mobile communication device 10a outputs the signals output for near field communication with the mobile communication device 10 using a pattern in which the output switches between an output intensity P₁ and an output intensity P₂ at a fixed interval as shown in FIG. 5. The mobile communication device 10a varies the intensity for outputting the signals based on the pattern, but does not vary the details of the signals.

Here, based on the pattern of the output of signals being output from the mobile communication device 10a, and the patterns of outputs stored in the memory part 24, the mobile communication device 10 determines that the mobile communication device 10a is being shaken.

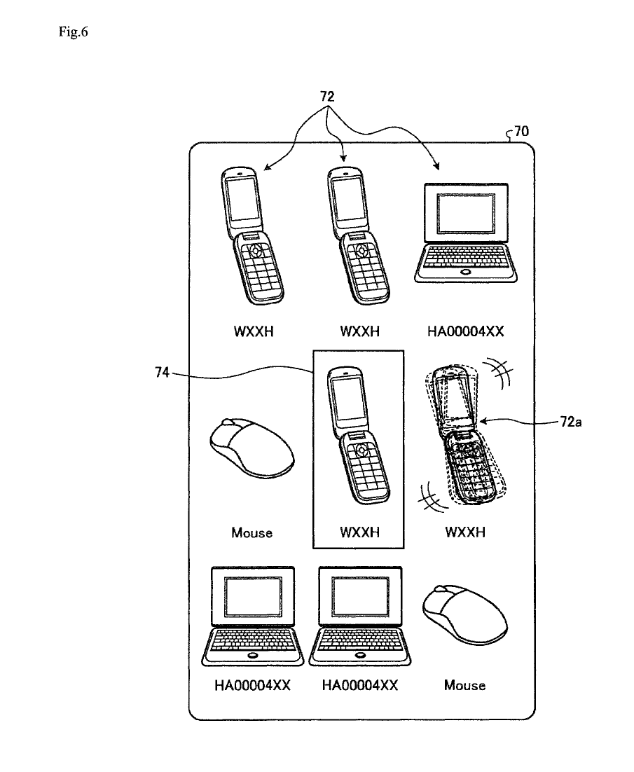

Next, in order to select and determine a communication partner, after obtaining information on each communication device, the mobile communication device 10 displays a screen 70 similar to the one shown in FIG. 6 on the display 12M. Here, icons 72 representing each communication device from which information on the communication device has been received are displayed on the screen 70. Here, the icons 72 are configured by images representing the types of the communication devices, and model information. The icon 72a displayed on the screen 70 is the icon representing the mobile communication device 10a that the mobile communication device 10 has determined is being shaken. The icon 72a is displayed as an animation so that the image representing the mobile communication device shakes. The icon 72a may also be a still image representing the fact that the mobile communication device is being shaken. A cursor 74 representing the selected position is also displayed on the screen 70. Then, by moving the cursor 74 and identifying the communication device with which to perform the pairing process, the mobile communication device 10 becomes able to transmit and receive data using near field communication. Of the communication devices with which communication is possible using the near field communication part, the mobile communication device 10 preferably displays only communication devices with which settings for pairing are possible. In other words, even for communication devices with which communication is possible using the near field communication part, it is preferable not to display communication devices with which pairing is not possible. In this way, the user is able to more appropriately select a communication device with which to perform pairing.

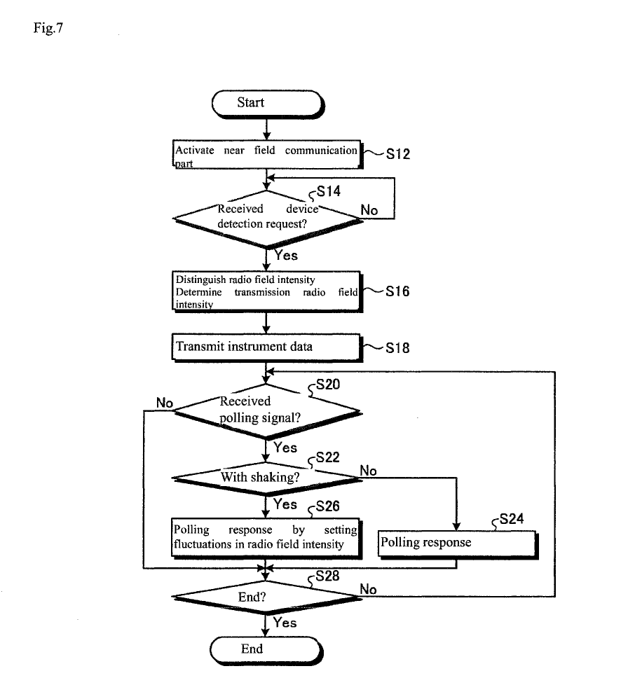

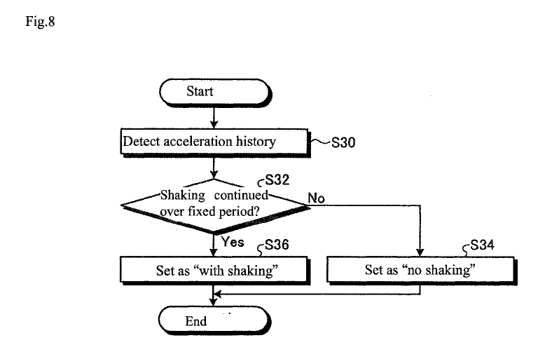

The following is a more detailed description of the processes of the mobile communication device 10a (i.e., the processes of the communication device being selected as a communication partner), with reference to FIG. 7 and FIG. 8. FIG. 7 and FIG. 8 describe the processes of the mobile communication device 10a. The mobile communication device 10a controls the operations of the near field communication part 36 by using the main control part 22.

First, in step S12, the main control part 22 of the mobile communication device 10a activates the near field communication part 36. The timing (trigger) for activating the near field communication part 36 is not particularly limited, and it may be activated by a user operation or in conjunction with activation of the device.

Subsequently, in step S14, the main control part 22 determines whether a device detection request has been received through near field communication. A device detection request is a signal output by another communication device (the mobile communication device 10 in the present embodiment) for detecting communication devices with which communication is possible. If the determination made in step S14 is that there has been no device detection request (No), the main control part 22 proceeds to step S14. In other words, the main control part 22 repeats the process of step S14 until a device detection request is detected.

If the determination made in step S14 is that a device detection request has been detected (Yes), the main control part 22 proceeds to step S16 and distinguishes the radio field intensity and determines the transmission radio field intensity. In other words, the main control part 22 detects the radio field intensity (signal intensity) of the received device detection request, and based on the detected results, determines the radio field intensity (signal intensity) to be transmitted. After determining the radio field intensity to be transmitted in step S16, the main control part 22 transmits instrument data in step S18. In other words, the main control part 22 transmits instrument data of the device itself using the radio field intensity determined in step S16. Instrument data are information such as the type, model and identification number of the communication device. The instrument data may also include information on the frequency used for communication. The frequency used for near field communication may be determined among the two instruments performing communication.

After transmitting the instrument data in step S18, in step S20, the main control part 22 determines whether a polling signal (communication-request signal) has been received. Here, a polling signal is a signal output by another communication device (the mobile communication device 10 in the present embodiment) to maintain the state of communication with the communication device that received the instrument data.

In step S20, if the main control part 22 determines that a polling signal has not been received (No), it proceeds to step S28. Alternatively, if in step S20 the main control part 22 determines that a polling signal has been received (Yes), it proceeds to step S22 and determines whether there is shaking. Specifically, the main control part 22 determines whether the results detected by the acceleration sensor 34 indicate “with shaking” or “no shaking”.

The following is a description of settings for “with shaking” and settings for “no shaking”, with reference to FIG. 8. The main control part 22 performs the processes of FIG. 7 and the processes of FIG. 8 in parallel as separate processes. First, in step S30, the main control part 22 detects an acceleration history. In other words, the main control part 22 detects a history of accelerations detected by the acceleration sensor 34. Subsequently, the main control part 30 determines whether shaking has continued for a fixed period. Here, “shaking” refers to a state in which changes in acceleration meet a standard state, such as, for example, a state in which the changes in acceleration within a unit time meet or exceed a standard value.

If the main control part 22 determines in step S32 that the shaking has not continued for a fixed period (No), it performs settings for “no shaking” in step S34. In other words, it determines that the device itself is not being shaken, and changes the settings from the shaking state to a non-shaking state. If the main control part 22 determines in step S32 that the shaking has continued for a fixed period (Yes), in step S36, it performs settings for “with shaking”. In other words, it determines that the device itself is being shaken and defines the settings for the shaking state as “with shaking”. After performing the processes of step S34 and step S36, the main control part 22 ends these processes. By repeating the processes shown in FIG. 8, the main control part 22 determines whether the device itself is being shaken.

Returning to FIG. 7, the following continues the description. In step S22, if the main control part 22 determines that the state is not “with shaking” (No) (i.e., that the settings for the shaking state are “no shaking”), it performs a polling response in step S24. A polling response is a signal output to the communication partner to provide notification that the polling signal has been received, or that communication is possible. The polling response includes, as digital information, information that identifies a terminal (the ID of the near field communication part, etc.). After performing the processes of step S24, the main control part 22 proceeds to step S28.

In step S22, if the main control part 22 determines that the state is “with shaking” (Yes) (i.e., that the settings for the shaking state are “with shaking”), it performs a polling response by setting fluctuations in radio field intensity. Here, a polling response performed by setting fluctuations in radio field intensity refers to a polling response output to the communication partner while fluctuating the pattern of the radio field intensity. In other words, the main control part 22 outputs the polling response while changing the output intensity according to a prescribed pattern. After performing the processes of step S26, the main control part 22 proceeds to step S28. The pattern of the radio field intensity is analog information, and even if the pattern of the radio field intensity of the polling response changes, the details of the digital information of the polling response do not change.

If the main control part 22 makes a determination of No in step S20, or performs the processes of step S24 and step S26, it determines whether to end (i.e., whether to end the communication process of the near field communication part). Various standards may be used for the standards for determining whether to end the communication process, and examples include ending the communication process if a signal indicating pairing with another communication device is received from the communication partner. If the main control part 22 determines not to end the communication process (No) in step S28, it proceeds to step S20 and repeats the processes of step S20 through step S28 described above. If the main control part 22 determines to end the communication process (Yes) in step S28, it ends the present process.

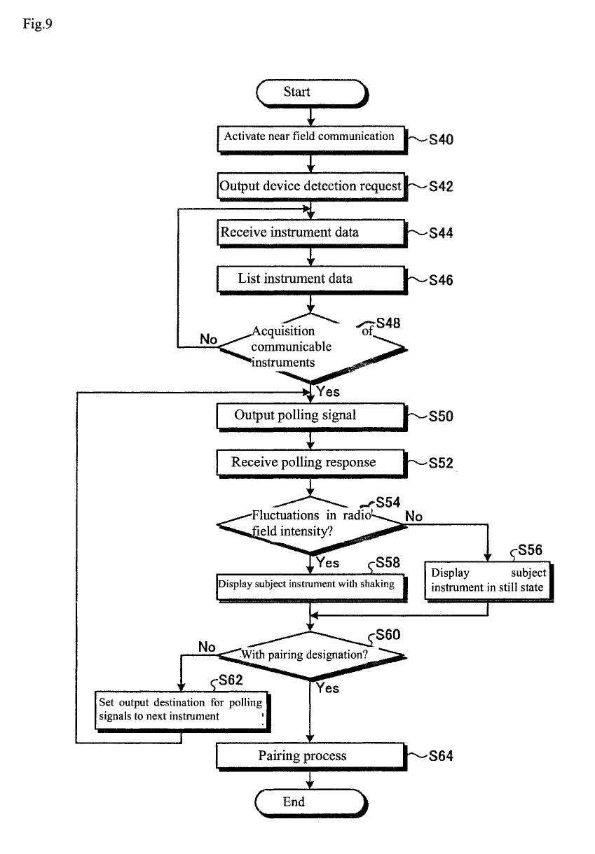

Next is a detailed description of the processes of the mobile communication device 10 (i.e., the processes of the communication device selecting a communication partner), with reference to FIG. 9. The mobile communication device 10 also controls the operations of the near field communication part 36 by using the main control part 22.

First, when an instruction to perform near field communication with another communication device is input, the main control part 22 of the mobile communication device 10 activates the near field communication part 36 in step S40. Subsequently, in step S42, the main control part 22 outputs a device detection request. In order to enable other communication devices within the area in which communication is possible to receive the device detection request, the main control part 22 outputs the device detection request at a prescribed output.

After outputting the device detection request in step S42, the main control part 22 receives instrument data in step S44. In other words, it receives instrument data output from communication devices that received the device detection request. After receiving the instrument data in step S44, in step S46, the main control part 22 displays a list of the instrument data based on the received instrument data. In other words, the main control part 22 receives the instrument data, and lists and displays information on communication devices for which communication (pairing) is determined to be possible on the main display 12M. For the list, images representing instruments in a typified manner and information on models, etc. are displayed.

After displaying the list in step S46, in step S48, the main control part 22 determines whether the acquisition of the data of the instruments with which communication is possible (the communication devices with which communication is possible) has been completed. In other words, the main control part 22 determines whether there are instrument data that have not been received. The main control part 22 is able to determines whether there are instrument data that have not been received by receiving signals that have reached the device itself and determining whether there are instrument data that have not been received. If the main control part 22 determines that the acquisition has not been completed (No) in step S48, it proceeds to step S44 and performs the processes of step S44 and S46.

If the main control part 22 determines that the acquisition has been completed (Yes) in step S48, in step S50, it outputs a polling signal. The main control part 22 performs output to one communication device from among the communication devices with which communication is possible (i.e., the communication devices from which instrument data were received in step S44). The communication devices performing communication have each been assigned a prescribed frequency, and by adjusting the frequency, it is possible to switch the communication device with which communication is performed.

After outputting the polling signal (communication-request signal) in step S50, in step S52, the main control part 22 receives a polling response. In other words, the main control part 22 receives a polling response output by the communication device to which the polling signal was transmitted by the communications part 26 in step S50. After receiving the polling response in step S52, in step S54, the main control part 22 determines whether there are fluctuations in the radio field intensity. In other words, the main control part 22 determines whether there are fluctuations in the output intensity of the signals of the polling response received in step S52. Here, as described above, the signals configuring the polling response are digital information, and the terminal with which communication is being performed is identified from the terminal-identifying information that configures the digital information. The output pattern (changes in radio field intensity) of the signals of the polling response is analog information, and even if the output pattern of the signals changes, the details of the signals (digital information) does not change. After receiving the polling response, the main control part 22 identifies the communication device of the communication partner based on the digital information of the received polling response, and identifies the state of the communication device based on the output intensity (analog information) of the signals of the polling response.

If the main control part 22 determines that there are no fluctuations (No) in step S54, in step S56, it displays the subject instrument in a still state. In other words, it displays the communication device that output the polling response in a still state. If the main control part 22 determines that there are fluctuations (Yes) in step S54, in step S58, it displays the subject instrument in a shaking state. In other words, it displays the communication device that output the polling response in a shaking state. For the display of the shaking state, the graphic of the communication device may be varied using animation, or a still image representing the shaking state may be displayed.

After the processes of step S56 and step S58 end, the main control part 22 determines whether there is a pairing designation in step S60. In other words, the main control part 22 determines whether an instruction determining a partner for pairing (i.e., a partner for performing data transmission and reception) has been input through a user operation. If the main control part 22 determines that there has been no pairing designation (No) in step S60, in step S62, it sets the output destination for polling signals to the next instrument and proceeds to step S50. In other words, it switches the communication device to which polling signals are output and performs the processes of step S50 through step S60.

If the main control part 22 determines that there is a pairing designation (Yes) in step S60, in step S64, it performs the pairing process and ends the present process. By performing the pairing process in step S64, the main control part 22 becomes able to transmit and receive data with the designated communication device. After the present process is ended, the main control part 22 moves to processes for performing data transmission and reception processes with the communication device with which the pairing process was performed.

In this way, by detecting the state of the communication device of a communication partner (i.e., by detecting the communication device being shaken) in accordance with the pattern of outputs of signals received via near field communication, the communication system 1 and the mobile communication device 10 are able to easily identify the communication device performing communication. Moreover, by detecting the state of the device itself with the acceleration sensor 34 and outputting signals using a pattern corresponding to that state, the mobile communication device 10a is also able to notify the communication partner of the state of the device itself.

As a result, by simply shaking the communication device with which to perform communication, the user is able to identify the communication device with which to perform communication from among multiple connectable communication devices that are displayed. As a result, the user is able to identify the communication device through easy operations, and is able to eliminate the bother of confirming the identification number or model. Moreover, because identification can be performed based on the state of the communication device, the user is able to easily switch the communication device to be identified. In other words, if the communication device with which to perform communication changes, by shaking that communication device, it is possible to easily identify the communication device on the screen.

Furthermore, by changing the pattern of the radio field intensity (the signal output pattern) without changing the digital information of the polling response (the signal being communicated) as in the present embodiment, it is possible to provide notification of the state of the communication terminal without changing the digital information. As a result, the communication terminal on the receiving side (i.e., the side receiving the polling response, or the side selecting the communication partner) is able to perform communication (i.e., pairing) using the near field communication part, even if it does not comprise functions for determining the state of a mobile terminal. In other words, if information indicating the state of the device itself is included in the digital information, the communication protocol ends up being changed, and communication terminals that do not comprise corresponding processing functions become unable to process the signals received during pairing. For this reason, when the communication device on the receiving side is a communication device that does not comprise processing functions for the digital information, the communication ends in error and it is not possible to perform near field communication. Alternately, by changing the output pattern of the signals without changing the digital information, it becomes possible to perform near field communication through the same processes even with a communication device that does not comprise functions for detecting the state of a communication device.

Moreover, by displaying images corresponding to the state of the communication devices on the display part, the mobile communication device 10 is able to more directly find a communication device. In the present embodiment, in order to understand the state of a communication device more directly and quickly, the state of the communication device of the communication partner is notified through a display on the screen, but the means for notification is not limited to a display on the screen. For example, notification of the state of the communication device may be provided through audio, or by vibrating the mobile communication device 10. For example, when the user moves the cursor and selects a communication device, notification may be provided to the user by outputting audio or by vibrating the chassis 10C.

In the above embodiment, the pairing process was performed after the user instruction was input, but the present invention is not limited to this. Once the state of a communication device is detected to be a prescribed state, the mobile communication device 10 may execute pairing with the communication device, or may enable the execution of data communication with that communication device.

In the above embodiment, for the signal pattern, the strength and weakness of the output intensity (radio field intensity) was changed within a prescribed interval, but the present invention is not limited to this. The signal may be switched between being output and not being output at a fixed cycle. In other words, an output pattern in which signals are output intermittently may be used. In this case, even if the signal is interrupted at a prescribed pattern, the communication device selecting the communication partner assumes that communication remains continuously connected and continues processing. In other words, it determines that the communication device is not in a state in which communication with the communication partner is not possible.

The signal pattern is not limited to the strength or weakness of the output, or to the presence or absence of an output, and it may include a signal indicating the state of the device itself as part of the signal. In other words, a pattern may be used in which a signal indicating the state of the device itself is added to the information of the instrument data, and the signal is output.

In the above embodiment, whether the device itself was being shaken was detected as the state of the device itself, but the present invention is not limited to this. For example, whether or not a light-emitting element acting as a marker is emitting light may be detected as the state of the device itself, and the pattern of the signals being output may be determined based on the results. In order to make it easy for the communication partner to grasp, the state of the device itself preferably refers to a state that may be confirmed visually.

In the communication system, it is sufficient as long as a communication device that selects a communication partner and a communication device that is selected by a communication partner perform near field communication based on the relationship of changes in the signal output pattern according to the state of the device itself as described above, and the communication device that selects a communication partner may comprise a communication device that performs defined near field communication regardless of the state of the device itself.

The communication device preferably comprises both the abovementioned communication device that selects a communication partner and a communication device that is selected by a communication partner, and may be used as either communication device as needed, but it may comprise only one.

As described above, the communication system and communication device according to the present invention are useful for performing communication through near field communication.

While at least one exemplary embodiment is presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A communication system comprising:
a first communication device comprising: a first near field communication part that performs near field communication; a state detection part that detects the state of the device itself; and a first control part that, based on the state of the device itself detected by the state detection part, selects an output pattern for signals output from the first near field communication part and controls the first near field communication part so as to output signals of the selected output pattern, and
a second communication device comprising: a notification part; a second near field communication part that performs near field communication with the first communication device; a memory part that stores the patterns of signals received by the second near field communication part associated with the state of the communication device; and a second control part that, in accordance with the pattern of signals received by the second near field communication part, identifies the state of the first communication device corresponding to the pattern of the received signals, and provides notification of the identified state of the first communication device via the notification part.

2. The communication system according to claim 1, wherein
the first communication device transmits the signals including information on the device itself via the first near field communication part, and
the second communication device upon receiving the signals, recognizes the first communication device as the communication partner by obtaining information regarding the first communication device, and identifies the state of the first communication device based on the pattern of the received signals.

3. A communication device comprising:
a near field communication part that performs near field communication with another communication device;
a state detection part that detects the state of the communication device itself; and
a control part that, in accordance with the state of the communication device itself detected by the state detection part, selects a pattern for signals to be output from the near field communication part from among multiple patterns, and control the first near field communication part so as to output signals of the selected pattern.

4. The communication device according to claim 3, wherein the control part control the near field communication part so as to transmit the signals including information regarding the device itself.

5. The communication device according to claim 3, wherein, in accordance with the state of the device itself detected by the state detection part, the multiple patterns each have different changes in the intensity of the signals output from the near field communication part.

6. The communication device according to claim 3, wherein, in accordance with the state of the device itself detected by the state detection part, the multiple patterns each have different intermittency patterns for the signals output from the near field communication part.

7. The communication device according to claim 3, wherein the control part, when receiving communication-request signals from the other communication device, selects the pattern of signals output from the near field communication device in accordance with the state of the device itself detected by the state detection part.

8. The communication device according to claim 3, wherein
the state detection part comprises an acceleration sensor that detects the acceleration of the device itself, and
the control part, in accordance with the acceleration detected by the acceleration sensor, selects a pattern associated with the detected acceleration.

9. A communication device comprising:
a notification part;
a near field communication part that performs near field communication with another communication device;
a memory part that stores the pattern of signals received via near field communication associated with the state of the communication device; and
a control part that, in accordance with the pattern of signals received from the other communication device by the near field communication part, identifies the state of the other communication device, and provides notification of the identified state of the other communication device via the notification part.

10. The communication device according to claim 9, wherein the control part, upon receiving the signals, recognizes the other communication device as the communication partner by obtaining information regarding the other communication device.

11. The communication device according to claim 9, wherein the control part transmits a communication-request signal to the other communication device, and then identifies the state of the other communication device based on the pattern of signals received by the near field communication part.

12. The communication device according to claim 9, wherein the control part obtains information regarding multiple other communication devices with which the near field communication part can communicate, and provides notification of the obtained information regarding the other communication devices via the notification part.

13. The communication device according to claim 9, wherein the pattern has a different changes in the intensity of the signals output from the near field communication part in accordance with the state of the other communication device.

14. The communication device according to claim 7, further comprising a display part, wherein
the control part controls the display part so as to display images representing multiple communication devices from which signals have been received by the near field communication part, and if these received signals include a signal in which the signal pattern is different, makes the image corresponding to the communication device that sent that signal different from the other communication devices.

15. The communication device according to claim 14, wherein the control part displays images representing communication devices possible to have settings for pairing from among the communication devices from which signals have been received.

16. A communication method comprising:
selecting an output pattern for signals by a first communication device, based on the state of the first communication device;
outputting the signals of the selected output pattern by the first communication device;
receiving the signals of the selected output pattern at a second communication device;
the second communication device identifying the state of the first communication device in accordance with the received signals of the selected output pattern;
providing notification of the identified state of the first communication device corresponding to the received signals of the selected output pattern.

17. The communication method according to claim 16, wherein outputting signals by the first communication device comprises transmitting the signals via a first near field communication.

18. A communication method for a communication device, comprising:
detecting the state of the communication device itself;
selecting a pattern for signals to be output from among multiple patterns in accordance with the state of the communication device itself detected;
outputting the signals of the selected pattern.

19. The communication method according to claim 18, wherein outputting the signals of the selected pattern comprises transmitting the signals using near field communication.

20. The communication method according to claim 18, wherein, in accordance with the state of the communication device itself, the multiple patterns each have at least one of different changes in the signal output intensity and different intermittency patterns.
